(19) United States
(12) Patent Application Publication
(10) Pub. No.: US 2007/0036258 A1
(43) Pub. Date: Feb. 15, 2007

(54) Process for producing radioactive fluorine compound

(76) Inventors: Osamu Ito, Sodegaura-shi (JP); Keiichi Hirano, Sodegaura-shi (JP); Takeshi Morita, Sodegaura-shi (JP); Fumie Kurosaki, Sodagaura-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/573,039

(22) PCT Filed: Sep. 28, 2004
(86) PCT No.: PCT/JP04/14184

§ 371 Date: Mar. 22, 2006

(30) Foreign Application Priority Data
Sep. 30, 2003 (JP) 2003-340784

(51) Int. Cl. C07F 5/00; G21G 1/06

(52) U.S. Cl. 376/168; 534/11

(57) ABSTRACT

A process for producing a radioactive fluorine compound which comprises a step in which [¹⁸O] water containing [¹⁸F] fluoride ions is introduced into a column packed with an ion-exchange resin to collect the [¹⁸F] fluoride ions and a step in which a substrate is reacted with the [¹⁸F] fluoride ions collected, characterized in that the ion-exchange resin is a resin represented by the following general formula (1): 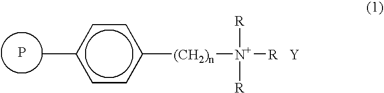
(wherein n is an integer of 1 to 10; R represents a linear or branched, C₁₋₈ monovalent hydrocarbon group; P represents a styrene-based copolymer; and Y represents an anion).

### TECHNICAL FIELD

The present invention relates to a method for producing a radioactive fluorine compound. Specifically, the present invention relates to a production method which can reliably obtain [¹⁸F]-radioactive fluorine compounds such as 2-[¹⁸F]fluoro-2-deoxy-D-glucose (hereinafter abbreviated as [¹⁸F]-FDG), various amino acid [¹⁸F]-fluorine compounds, [¹⁸F]-fluorotosyloxyethane, and [¹⁸F]-fluorotosyloxypropane, at a high yield from a large amount of [¹⁸O] water containing [¹⁸F] fluoride ions.

### BACKGROUND ART

In the past, various methods for obtaining [¹⁸F]-FDG have been proposed, such as, for example, the Hamacher method which conducts labeled synthesis in a reaction vessel, or the on-column method which conducts labeled synthesis in a column.

The Hamacher method will now be described (J. Nucl. Med., 27, pp. 235-238 (1986); Appl. Radiat. Isot., Vol. 41, No. 1, pp. 49-55 (1990)). First, [¹⁸O] water containing [¹⁸F] fluoride ions is passed through a column packed with anion exchange resin to collect the [¹⁸F] fluoride ions. The [¹⁸O] water that was used is recovered for recycling. Next, aqueous potassium carbonate is introduced into the column to elute the [¹⁸F] fluoride ions contained therein, and the resulting solution is recovered in a reaction vessel. This reaction vessel is charged with acetonitrile in which aminopolyether (cryptand [2.2.2]) as a phase transfer catalyst is dissolved. The vessel contents are evaporated to dryness to activate the [¹⁸F] ions. Acetonitrile with the substrate 1,3,4,6-tetra-O-acetyl-2-O-trifluoromethanesulfonyl-β-D-mannopyranose (hereinafter, TATM) dissolved therein is introduced into the vessel. A nucleophilic substitution takes place in the reaction vessel, whereby the [¹⁸F]-FDG intermediate 1,3,4,6-tetra-O-acetyl-2-[¹⁸F]fluoro-2-deoxy-D-glucose (hereinafter, [¹⁸F]-TAFDG) is formed. This intermediate product is deprotected (hydrolyzed) and purified to obtain [¹⁸F]-FDG.

According to this Hamacher method, if between 2 mL and 2.5 mL of [¹⁸F] fluoride ion-containing [¹⁸O] water is used, the collection rate of [¹⁸F] fluoride ions into the anion exchange resin is 95%, the [¹⁸F]-TAFDG yield is 95% and the [¹⁸F]-FDG yield is between 40 and 55%, whereby a radioactive fluorine compound [¹⁸F]-FDG can be produced in a synthesis time of about one hour.

Next, the on-column method will be explained. The on-column method is a method wherein [¹⁸F]-TAFDG is obtained by introducing an acetonitrile solution with TATM dissolved therein into a column in which [¹⁸F] fluoride ions have been collected. Examples include a method which uses 4-aminopyridinium resin for an ion exchange resin (Mulholland method) and a method which uses a phosphonium-salt-containing resin (JP-A-8-325169).

As the Mulholland method, a method which uses a column packed only with 4-aminopyridinium resin (J. Labelled. Compd. Radipha., 26 (1989)), and a method which uses a column packed with a mixed bed consisting of 4-aminopyridinium resin and a fibrous anion exchange resin (Nucl. Med. Bio., Vol. 17, No. 3, pp. 273-279 (1990)) have been proposed.

The first Mulholland method uses a column that is packed with 4-aminopyridinium resin obtained by heating 4-(N,N-dialkyl)aminopyridine and a chloromethylpolystyrene-divinylbenzene copolymer (i.e. a “Merryfield resin”) in acetonitrile (J. Labelled. Compd. Radipha., 26 (1989)). 2N NaOH is passed through the column so that the resin undergoes hydroxylation (OH⁻). [¹⁸F] fluoride ion-containing [¹⁸O] water is introduced into the resulting column, whereby [¹⁸F] fluoride ions are collected therein. The [¹⁸O] water that was used is recovered for recycling. Acetonitrile or dimethylsolfoxide is passed through the column to carry out dehydration, whereby the [¹⁸F] fluoride ions are activated. An acetonitrile solution with TATM dissolved therein is then added to cause a nucleophilic substitution reaction to take place between the [¹⁸F] fluoride ions in the column and the substrate TATM, whereby [¹⁸F]-TAFDG is formed. This product is deprotected (hydrolyzed) and further purified, to thereby obtain [¹⁸F]-FDG.

According to this method, if 1 mL of [¹⁸F] fluoride ion-containing [¹⁸O] water is used, the collection rate of [¹⁸F] fluoride ions is between 75 and 90%. When the substrate is aliphatic, the fluorination reaction yield is from 40 to 65%, and from 20 to 35% in case of aromatic.

In the Mulholland method, a column is used that is packed with a 4-aminopyridinium resin, which is obtained by heating 4-(4-methyl-1-piperidino)pyridine, chloromethylpolystyrene: 2% crosslinked divinylbenzene copolymer beads (i.e. a “Merryfield resin” having a chlorine content of 1.2 equivalent/g) in acetonitrile, and a fibrous anion exchange resin (Nucl. Med. Bio., Vol. 17, No. 3, pp. 273-279 (1990)). 1.8 M of K₂CO₃ is passed through this column so that the resin is converted into CO₃²⁻. [¹⁸F] fluoride ion-containing [¹⁸O] water is introduced into the resulting column, whereby [¹⁸F] fluoride ions are collected. [¹⁸F]-FDG is subsequently obtained in the same manner as described above.

In this method, when the mixing ratio of 4-aminopyridinium resin to the fibrous anion exchange resin is 4:1, the collection rate of [¹⁸F] fluoride ions is approximately 66%, and the fluorination reaction yield is approximately 77%. When the mixing ratio is 6:1, the collection rate is approximately 95% and the fluorination reaction yield is approximately 61%. Synthesis can be carried out in 40 minutes.

Further, a method has been proposed (JP-A-8-325169) concerning the above-described on-column method using a resin containing a phosphonium salt, wherein in place of the column filler of the above-described Mulholland method, a resin containing a phosphonium salt is packed into the column, and [¹⁸F] fluoride ion-containing [¹⁸O] water is passed through the column to collect [¹⁸F] fluoride ions. [¹⁸F]-FDG is subsequently obtained in the same manner as described above.

In this method, when between 20 and 30 mg of resin and 4 mL of the [¹⁸F] fluoride ion-containing water are used, the [¹⁸F] fluoride ion collection rate is 99%.

However, the above-described conventional art suffers from various drawbacks which need to be further improved upon.

For example, in the Hamacher method, there are a large number of operation steps and too much time is required for synthesis, which results in the decay of [¹⁸F] over time (half-life of 109.7 minutes) during production. As a consequence, there is the problem that the [¹⁸F] fluorine compound yield decreases. In addition, in the Hamacher method, since a toxic aminopolyether is employed, there is the problem that a complex operation for removing the aminopolyether is required when using as a pharmaceutical.

On the other hand, with an on-column method which uses a 4-aminopyridinium resin, since the active group, which is toxic 4-aminopyridine, is fixed to the resin, the active group does not escape from the system. Thus, there is no need for the evaporation to dryness or aminopolyether removal steps, which allows the number of steps to be reduced compared with the Hamacher method, thereby enabling the synthesis time to be shortened. However, in an on-column method, to sufficiently bring the acetonitrile solution with TATM dissolved therein into contact with the 4-aminopyridinium resin, the solution has to be passed back and forth through the column a number of times. Also, since pyridinium salts are hydrophilic groups, 4-aminopyridinium resins are highly hydrophilic. Therefore, due to the nature, it is to expand with highly polar solvents and contract with solvents that are not very polar. This means that if the packed resin expands, the pressure in the column when the solvent is being passed therethrough becomes very high, resulting in the fluidity of the substrate-containing solvent decreasing. There is also the problem that contraction causes the column efficiency to deteriorate.

Although the on-column method which uses a mixed bed consisting of 4-aminopyridinium resin and a fibrous anion exchange resin (Nucl. Med. Bio., Vol. 17, No. 3, pp. 273-279 (1990)) overcomes the above-described fluidity problem of on-column methods, it suffers from the drawback that fibrous anion exchange resins are expensive. Moreover, if the amount of fibrous anion exchange resin is decreased, there are the problems that the improvement in fluidity is not achieved and that reaction efficiency decreases.

An experiment conducted using an on-column method which employed a resin containing a phosphonium salt showed that when a large amount of [¹⁸F] fluoride ion-containing [¹⁸O] water was used with this method, the collection rate of [¹⁸F] fluoride ions decreased, and as a result total yield decreased. It was further learned that, in this method, when the amount of [¹⁸F] fluoride ion-containing [¹⁸O] water was increased, total yield further decreased. This comparative experiment will be described below in more detail in Example 1.

In the production of [¹⁸F] by a cyclotron, static-type targets which employ a few grams of [¹⁸O] water as a raw material have often been used. However, in recent years, in order to produce a greater amount of [¹⁸F], it has become possible to use circulating targets which can employ large amounts of the raw material of [¹⁸O] water. In view of this background, there is a need for a method which can efficiently produce a radioactive fluorine compound without the yield decreasing even if a large amount of [¹⁸F] fluoride ion-containing [¹⁸O] water is used; i.e. over a broad range of [¹⁸O] water treatment amount.

### DISCLOSURE OF THE INVENTION

The present invention was created in view of the above-described matters, and it is thus an object of the present invention to provide a method for producing a radioactive fluorine compound which can obtain a radioactive fluorine compound at a good yield and reliably. In particular, it is an object of the present invention to provide a production method wherein [¹⁸F] fluoride ions can be collected efficiently and wherein the labeling index is high, over a broad range of [¹⁸F] fluoride ion-containing [¹⁸O] water treatment solution of a small amount of about 1 g to a large amount of 10 g or more. That is, it is an object of the present invention to provide a method for producing a radioactive fluorine compound which is preferable in obtaining at a good yield various radioactive fluorine compounds such as [¹⁸F]-FDG, various amino acid [¹⁸F]-fluorine compounds, [¹⁸F]-fluorotosyloxyethane, and [¹⁸F]-fluorotosyloxypropane.

As a result of diligent investigation into achieving the above-described objects, the present inventors arrived at the present invention that, in a method for producing a radioactive fluorine compound comprising the steps of introducing [¹⁸O] water containing [¹⁸F] fluoride ions into a column packed with an ion exchange resin to collect fluoride ions, and causing a substrate to react with the collected [¹⁸F] fluoride ions, the use of a resin represented by the following general formula (1) for the above-described ion exchange resin allowed a desired radioactive fluorine compound to be reliably obtained at a good yield. In particular, according to the production method of the present invention, [¹⁸F] fluoride ions can be collected at a good yield not only at a low amount (about 1 g) of [¹⁸F] fluoride ion-containing [¹⁸O] water, but also at a high amount (between 10 and 20 g, inclusive thereof) as well. Further, since fluorination rate of reaction is high, the [¹⁸F] fluorine compound yield becomes very high. Therefore, the method for producing a radioactive fluorine compound according to the present invention can obtain at a good yield radioactive fluorine compounds such as [¹⁸F]-FDG, various amino acid [¹⁸F] fluorine compounds, [¹⁸F]-fluorotosyloxyethane, and [¹⁸F]-fluorotosyloxypropane.

That is, the present invention provides a method for producing a radioactive fluorine compound comprising the steps of introducing [¹⁸F] fluoride ion-containing [¹⁸O] water into a column packed with an ion exchange resin to collect [¹⁸F] fluoride ions, and causing a substrate to react with the collected [¹⁸F] fluoride ions, characterized in that the ion exchange resin is represented by the following general formula (1): 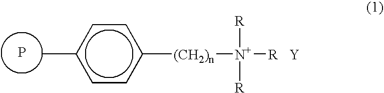
wherein n represents an integer from 1 to 10; R represents a linear or branched monovalent hydrocarbon group having 1 to 8 carbon atoms; P represents a styrene copolymer; and Y represents an anion.

The present invention also provides a method for producing a radioactive fluorine compound using the above-described ion exchange resin, wherein, in the above-described general formula (1) n is 1, R is a linear butyl group, Y is CO₃²⁻ or HCO³⁻ and P is a polystyrene-divinylbenzene copolymer.

The production method according to the present invention can obtain [¹⁸F]-FDG, fluorine compounds of amino acids and their intermediates, a glycol ditosylate fluorine compound and the like, reliably and at a good yield from [¹⁸F] fluoride ion-containing [¹⁸O] water. According to the production method of the present invention, the amount of [¹⁸F] fluoride ion-containing [¹⁸O] water treatment solution that is used can be within a broad range from a low amount to a high amount.

### BRIEF DESCRIPTION OF THE DRAWINGS

FIG. 1 is a schematic diagram illustrating one embodiment of the production process according to the present invention.

### DESCRIPTION OF THE REFERENCE NUMERALS

1 Target box
2 Target water container
3 Syringe pump
4 Valve
5 Resin column for labeled synthesis
6 Recovery container
7 Acetonitrile container
8 Waste liquid container
9 TATM container
10 Ion exchange resin column
11 Hydrolysis solution container
12 Purification column

### BEST MODE FOR CARRYING OUT THE INVENTION

The production method according to the present invention will now be described in more detail. The production method according to the present invention comprises a step of introducing [¹⁸F] fluoride ion-containing [¹⁸O] water into a column to collect the [¹⁸F] fluoride ions in the column. From the fact that labeled synthesis is conducted in a column, the production method according to the present invention is classified as a so-called on-column production method. Here, the [¹⁸F] fluoride ion-containing [¹⁸O] water can be produced by following an ordinary method, and can be obtained, for example, by subjecting [¹⁸O] water to proton irradiation as a target.

To collect the [¹⁸F] fluoride ions, the production method according to the present invention packs a column with a resin represented by the following general formula (1): 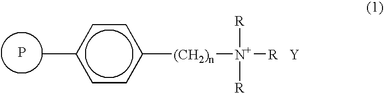
wherein n represents an integer from 1 to 10; R represents a linear or branched monovalent hydrocarbon group having 1 to 8 carbon atoms; P represents a styrene copolymer; and Y represents an anion.

Here, in the above formula, n represents an integer from 1 to 10, preferably from 1 to 3, and most preferably 1. R represents a linear or branched monovalent hydrocarbon group having 1 to 8 carbon atoms, and is preferably a linear butyl group. P represents a styrene copolymer, and is preferably a polystyrene-divinylbenzene copolymer. Y represents an anion, and is preferably CO₃²⁻ or HCO³⁻.

Therefore, particularly preferable resins represented by the above general formula (1) include ion exchange resins wherein n is 1, R is a linear butyl, Y is CO₃²⁻ or HCO³⁻ and P is a polystyrene-divinylbenzene copolymer.

The ion exchange resin according to the present invention can be obtained by, for example, subjecting the chloride ions of an ion exchange resin containing the tributylmethylammonium chloride group represented by the following general formula (2) to CO₃²⁻ or HCO³⁻ substitution. This treatment can be carried out in accordance with well-known methods. For example, the chloride ions can be substituted with CO₃²⁻, HCO³⁻ or the like by using potassium carbonate, sodium carbonate, potassium bicarbonate, sodium bicarbonate or the like. 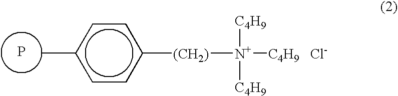
(wherein P in the above formula represents a styrene copolymer)

The active group of the resin represented by the above general formula (1) is preferably between 1.0 and 1.3 mmol/g, and especially preferably 1.2 mmol/g. A commercially available resin may be preferably employed. Despite having comparatively fewer active groups than the conventional art, the ion exchange resin according to the present invention can not only efficiently collect [¹⁸F] fluoride ions, but can also collect [¹⁸F] fluoride ions at a high yield in cases where the [¹⁸F] fluoride ion-containing [¹⁸O] water treatment amount is a low amount of about 1 g, as well as a large amount of about 10 g or more.

The packed amount of the ion exchange resin according to the present invention may be selected as appropriate depending on the amount of [¹⁸F] fluoride ion-containing [¹⁸O] water to be treated and the inner diameter of the column. For example, when treating [¹⁸F] fluoride ion-containing [¹⁸O] water using a 6 mm inner diameter column, if the amount of [¹⁸O] water to be treated is 20 g, 0.3 mL of resin or more can be used, and if the amount of [¹⁸O] water to be treated is 10 g, 0.2 mL of resin or more can be used. When the amount of [¹⁸O] water to be treated is 5 g or less, 0.1 mL of resin is sufficient.

In the present invention there are no limitations on the column for packing the above-described ion exchange resin. A column which would be used in an ordinary on-column method may be employed. For example, the column disclosed in Japanese Patent Application No. 2003-75650 previously filed by the present applicant can be preferably employed. That column can preferably cope with the expansion and contraction of the resin, and can be packed with a larger amount of the ion exchange resin used in the present invention. Because of this, the column is available for production of a radioactive fluorine compound using [¹⁸F] fluoride ion-containing [¹⁸O] water in a broad range of from about 1 g to the large amount of 10 g or more.

In the production method according to the present invention there are no particular limitations on the procedures after collecting the [¹⁸F] fluoride ions in the column, and well-known methods may be followed. For example, a nucleophilic substitution reaction can be carried out by passing acetonitrile or dimethylsulfoxide through a column in which [¹⁸F] fluoride ions have been collected to carry out dehydration, and further adding thereto a solvent with a substrate dissolved therein. Accordingly, for the [¹⁸F]-FDG production method, [¹⁸F]-FDG can be produced by further hydrolysis and purification of the [¹⁸F]-TAFDG obtained from a nucleophilic substitution reaction.

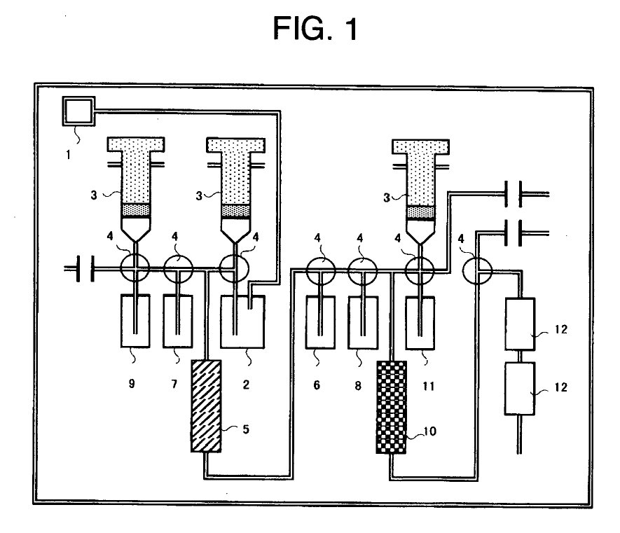

The production method according to the present invention will be explained here with reference to the drawings. FIG. 1 is a diagram illustrating one example of a production line for the production method according to the present invention. In FIG. 1, reference numeral 1 represents a target box, reference numeral 2 represents a target water container, reference numeral 3 represents a syringe pump, reference numeral 4 represents a valve, reference numeral 5 represents a resin column for labeled synthesis, reference numeral 6 represents a recovery container, reference numeral 7 represents an acetonitrile container, reference numeral 8 represents a waste liquid container, reference numeral 9 represents a TATM container, reference numeral 10 represents an ion exchange resin column, reference numeral 11 represents a hydrolysis solution container and reference numeral 12 represents a purification column. The resin column for labeled synthesis 5 mentioned here is packed with at least one kind of resin represented by the below chemical formulae (3) and (4).

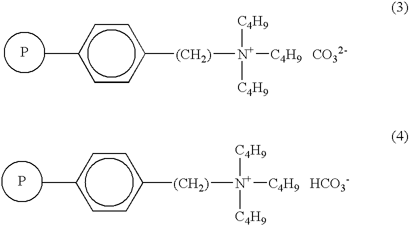

Next, the production of [¹⁸F]-FDG using the production line illustrated in FIG. 1 will be explained. First, [¹⁸F] fluoride ion-containing [¹⁸O] water is stored in the target water container 2 from the target box 1 by adjusting the cylinder pump 3 and valve 4, and then introduced into the resin column for labeled synthesis 5. At the column 5, the ion exchange resin according to the present invention collects [¹⁸F] fluoride ions. The introduced [¹⁸O] water is discharged out of the column by using an appropriate gas such as helium gas or nitrogen gas, and is then stored in the recovery container 6 for recycling.

Subsequently, dehydrated acetonitrile was introduced into the column 5 from the acetonitrile container 7 to dehydrate the column contents. The used acetonitrile was recovered in the waste liquid container 8.

Further, an acetonitrile solution with TATM dissolved therein was introduced into the resin column for labeled synthesis 5 from the TATM container 9. After [¹⁸F]-TAFDG had been formed from a nucleophilic substitution reaction, the [¹⁸F]-TAFDG was introduced along with an acetonitrile solution into the ion exchange resin column 10.

An acidic or alkaline hydrolysis solution was charged from the hydrolysis solution container 11 into the ion exchange resin column 10 into which the [¹⁸F]-TAFDG had been introduced. The [¹⁸F]-TAFDG was hydrolyzed in the column to form [¹⁸F]-FDG, which was then purified in the purification column 12 to obtain [¹⁸F]-FDG.

According to the production method of the present invention, a specific ion exchange resin is packed into the resin column for labeled synthesis 5, whereby [¹⁸F] fluoride ions are optimized so that they can be efficiently collected. This enables a dramatic improvement in the labeling index and the desired radioactive fluorine compound to be obtained at a good yield and reliably. For example, in a [¹⁸F] fluoride ion-containing [¹⁸O] water treatment solution amount over a broad range of from a low amount of about 1 g to a large amount of 10 g or more, [¹⁸F]-TAFDG production can be conducted at a good yield without requiring any special procedures, and [¹⁸F]-FDG can therefore be produced at a good yield.

The various radioactive fluorine compounds produced by the present invention can be either an intermediate or a final product. That is, in the present invention, the term “radioactive fluorine compound” refers to a compound bound with a [¹⁸F] fluoride ion that was collected in a column using the production method according to the present invention. Examples include [¹⁸F]-FDG, fluorine compounds of amino acids and their intermediates, and fluorine compounds of glycol ditosylates. Specific examples include [¹⁸F]-TAFDG, intermediates of [¹⁸F]-FMACBC (fluoromethylaminocyclobutanecarboxylic acid), intermediates of [¹⁸F]-FACBC (fluoroaminocyclobutanecarboxylic acid), intermediates of [¹⁸F]-FET (fluoroethyltyrosine), intermediates of [¹⁸F]-FEtOTs (fluorotosyloxyethane), and intermediates of [¹⁸F]-FPrOTs (fluorotosyloxypropane). According to the production method of the present invention, an [¹⁸F]-FMACBC intermediate having a purity of 81.3% and [¹⁸F]-FPrOTs having a purity of 84.6% can, for example, be obtained. When obtaining the above-described various radioactive fluorine compounds, other than using the ion exchange resin according to the present invention, there are no particular limitations, and well-known methods may be employed.

The present invention will now be explained in further detail with reference to the following Examples and Comparative Examples according to the present invention. The present invention is, however, not limited to these Examples.

### EXAMPLE 1

Synthesis of [¹⁸F]-TAFDG

[¹⁸F]-TAFDG was synthesized according to the below steps (1) to (3).

(1) [¹⁸F] fluoride ion-containing [¹⁸O] water formation step: [¹⁸O] water was subjected to proton irradiation in a cyclotron, whereby radioactive fluorine-18 ([¹⁸F]) was generated according to the nuclear reaction (¹⁸O (p,n)→¹⁸F), to thereby obtain [¹⁸F] fluoride ion-containing [¹⁸O] water.

(2) [¹⁸F] collecting step: [¹⁸F] fluoride ion-containing [¹⁸O] water in the amount shown in Table 1 was introduced at a rate of 2 mL/min into a column (6 mm inner diameter) packed with 0.2 mL TBA resin (Example 1) or TBP resin (Comparative Example 1), whereby [¹⁸F] fluoride ions were collected.

(3) Fluorination step: Acetonitrile was charged for 1 minute at room temperature and at a flow rate of 10 mL/min into the column in which [¹⁸F] fluoride ions were collected, to carry out dehydration. The column was further heated with a heater to 95° C. while helium gas was being passed therethrough. This state was maintained for 3 minutes, after which 1.0 mL of a solution wherein 20 mg of TATM had been dissolved in 1.0 mL of acetonitrile was introduced into the column to cause the TATM and the fluoride ions to react, whereby [¹⁸F]-TAFDG was obtained.

The below expressions were used to calculate the [¹⁸F] fluoride ion collection rate (%), the [¹⁸F]-TAFDG labeling index (%), and the [¹⁸F]-TAFDG yield (%). The results are shown in Table 1.

$$\begin{matrix}[ Expression 1 ] & \\ \begin{matrix}[ {}^{18} F ] flouride ion \\ collection rate ( \% )\end{matrix} = \frac{\begin{matrix}amount of \\ radioactivity ( Bq ) of \\ the collected [ {}^{18} F ] flouride ions \end{matrix}}{\begin{matrix}amount of \\ radioactivity ( Bq ) of the \\ collected [ {}^{18} F ] flouride ions - \\ containing [ {}^{18} O ] water\end{matrix}} \times 100 & ( 1 ) \\ [ Expression 2 ] & \\ \begin{matrix}[ {}^{18} F ] TAFDG \\ labeling index ( \% )\end{matrix} = \frac{\begin{matrix}amount of \\ radioactivity ( Bq ) of \\ the collected [ {}^{18} F ] - TAFDG \end{matrix}}{\begin{matrix}amount of \\ radioactivity ( Bq ) of \\ the collected [ {}^{18} F ] flouride ions \end{matrix}} \times 100 & ( 2 ) \\ [ Expression 3 ] & \\ \begin{matrix}[ {}^{18} F ] - TAFDG \\ yield ( \% )\end{matrix} = \frac{\begin{matrix}collection rate of \\ the [ {}^{18} F ] fluoride ions\end{matrix} \times \begin{matrix}[ {}^{18} F ] - TAFDG \\ labeling index \end{matrix}}{100} & ( 3 )\end{matrix}$$

In the above-described production method, the TBA resin of the Example was a resin in which the chloride ion of Fluka 90806 (tributymethylammonium chloride polymer bound, manufactured by Sigma Aldrich) was substituted with a carbonate ion, and the TBP resin of the Comparative Example was a resin in which the chloride ion of Fluka 90808 (tributymethylammonium chloride polymer bound, manufactured by Sigma Aldrich) was substituted with a carbonate ion. 1.8 M of K₂CO₃ was used for each of the anion substitutions of these resins.

TABLE 1

| | | [¹⁸F]- | | | |
|---|---|---|---|---|---|
| | | Containing | [¹⁸F] | | |
| | | [¹⁸O] | Fluoride | [¹⁸F]- | Total |
| | Ion | Water | Ion Resin | TAFDG | Yield |
| | Exchange | Amount | Collection | Labeling | (calculated |
| | Resin | (g) | Rate | Index | value) |
| Example 1 | TBA | 1 | 100.0% | 90.3% | 90.3% |
| | resin | 5 | 98.3% | 88.7% | 87.2% |
| | | 11 | 92.7% | 86.0% | 79.7% |
| | | 12 | 92.6% | 81.1% | 75.1% |
| Com- | TBP | 1 | 99.0% | 84.0% | 83.2% |
| parative | resin | 5 | 73.8% | 77.4% | 68.9% |
| Example 1 | | 7 | 54.2% | 73.2% | 39.7% |
| | | 11 | 24.5% | 60.0% | 14.7% |

As seen from the results of Table 1, the production method according to the present invention was able to achieve a high [¹⁸F] fluoride ion collection rate and a high [¹⁸F]-TAFDG labeling index for a broad [¹⁸O] water treatment amount of from 1 g to 12 g (Example 1).

In contrast to this, in the method which used the TBP resin shown in Comparative Example 1, when the treatment amount of [¹⁸O] water was 1 g, both the collection efficiency of the [¹⁸F] fluoride ions and the labeling index of [¹⁸F]-TAFDG showed a high value; although in the case of 5 g or more, both the collection rate of the [¹⁸F] fluoride ions and the labeling index of [¹⁸F]-TAFDG were less than 80%, which was lower than the production method using a TBA resin shown in Example 1. Further, it was shown that collection rate and labeling index tend to decrease for greater treatment amounts of [¹⁸] water.

From the above results, it was confirmed that the production method according to the present invention has a high collection rate of [¹⁸F] fluoride ions, as well as a high fluorine labeling index, and is thus an excellent production method for obtaining [¹⁸F]-TAFDG at a good yield.

### EXAMPLE 2

Fluorination of an Amino Acid and Glycol Ditosylate

Employing a column packed with 0.2 mL of TBA resin which was the same as that in Example 1, an intermediate (1-N-tert-butoxycarbamate-3-[¹⁸F]fluoro-1-cyclobutane-1-carboxylic acid tert-butyl ester) of fluoromethylaminocyclobutanecarboxylic acid (hereinafter “FMACBC”), an intermediate (1-N-tert-butoxycarbamate-3-[¹⁸F]fluoro-1-cyclobutane-1-carboxylic acid methylester) of fluoroaminocyclobutanecarboxylic acid (hereinafter FACBC), an intermediate (O-(2-[¹⁸F]fluoroethyl)-N-tert-butoxycarbonyl-L-tyrosine tert-butyl ester) of fluoroethyltyrosine (hereinafter “FET”), 2-[¹⁸F]fluoroethyl-p-tosylate (hereinafter “FEtOTs”) and 3-[¹⁸F]fluoropropyl-p-tosylate (hereinafter FPrOTs) were obtained using the substrates as shown in Table 2.

For each of the substrates, an amount equivalent to 100 μmol thereof was dissolved in 1.0 mL of acetontrile, and the resulting solutions were introduced into a column. In addition, for each of the substrates, the above substrate acetonitrile solution was introduced into a column that had been heated to 95° C. by flowing thereinto at a rate of 0.33 mL/min. The respective yields for the obtained radioactive fluorine compounds are shown in Table 2.

TABLE 2

| | Substrate | Yield |
|---|---|---|
| FMACBC | 1-N-tert-butoxycarbamate-3-p-nosiloxy-1- | 81.3% |
| Intermediate | cyclobutane-1-carboxylic acid t-butyl | |
| | ester | |
| FACBC | 1-N-tert-butoxycarbamate-3- | 63.8% |
| Intermediate | trifluoromethanesulfonyl-1-cyclobutane-1- | |
| | carboxylic acid methyl ester | |
| FET | O-(2-p-tosiloxyethyl)-N-tert- | 86.8% |
| Intermediate | butoxycarbonyl-L-tyrosine tert-butyl ester | |
| FEtOTs | ethylene glycol-1,2-di-p-tosylate | 52.0% |
| FPrOTs | 1,3-propanediol-p-tosylate | 84.6% |

As seen from the results of Table 2, the production method according to the present invention was able to produce radioactive fluorine compounds, such as various amino acids and glycols, at a good yield.

1. A method for producing a radioactive fluorine compound comprising the steps of: introducing [¹⁸F] fluoride ion-containing [¹⁸O] water into a column packed with an ion exchange resin to collect [¹⁸F] fluoride ions; and causing a substrate to react with the collected [¹⁸F] fluoride ions, characterized in that the ion exchange resin is represented by the following general formula (1): 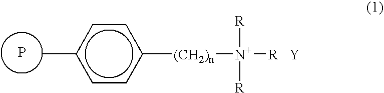
wherein n represents an integer from 1 to 10; R represents a linear or branched monovalent hydrocarbon group having 1 to 8 carbon atoms; P represents a styrene copolymer; and Y represents an anion.

2. The method for producing a radioactive fluorine compound according to claim 1, wherein, in the ion exchange resin of the general formula (1), n is 1, R is a linear butyl group, Y is CO₃²⁻ or HCO₃₋ and P is a polystyrene-divinylbenzene copolymer.

3. The method for producing a radioactive fluorine compound according to claim 1, wherein the [¹⁸F] fluoride ion-containing [¹⁸O] water is introduced into the column in an amount of 1 g to 20 g.
